(19) United States
(12) Patent Application Publication
(10) Pub. No.: US 2013/0319261 A1
(43) Pub. Date: Dec. 5, 2013

(54) Method and Apparatus for Material Densification

(71) Applicants: John T. Kelly, Saratoga, CA (US); Nehru Chevanan, Fremont, CA (US); George Raymond Miller, Los Gatos, CA (US)

(72) Inventors: John T. Kelly, Saratoga, CA (US); Nehru Chevanan, Fremont, CA (US); George Raymond Miller, Los Gatos, CA (US)

(73) Assignee: Altex Technologies Corporation, Sunnyvale, CA (US)

(21) Appl. No.: 13/486,840

(22) Filed: Jun. 1, 2012

(51) Int. Cl. C10L 5/10; B30B 15/34; C10L 5/44

(52) U.S. Cl. 100/38; 100/316

(57) ABSTRACT

A process and apparatus for densification of material compresses the material, then heats and cools the compressed material to provide structural integrity and durability to the resultant densified product. For a lignocellulosic biomass material an inherent binder is used. The binder is activated substantially only along the periphery of the compressed material to increase throughput and reduce energy used during the densification process.

The invention was made with Government support under DE-FG02-08ER85187 awarded by the Department of Energy (DOE). The Government has certain rights in the invention.

### FIELD OF THE INVENTION

The present invention relates to densification of material, such as lignocellulosic biomass.

### BACKGROUND OF THE INVENTION

Densification is an important unit operation involved in utilization of initially lower density material, because it reduces handling, storage and transportation costs. Lignocellulosic biomass material is one material type that benefits from densification. At present, biomass is densified for production of Solid Fuel (eg. Wood pellets) used in stoves for heating in the US and elsewhere, for use in utility (pulverized coal firing) and industrial boilers (stokers firing lumps 0.5 inches in diameter) and in the co-firing of coal and biomass in power plants to achieve renewable goals. Animal feed materials such as Alfalfa and others are also densified to lower transport, handling and storage costs for distant domestic and foreign export markets. In addition, agriculture residues and energy crops such as corn stover, wheat straw, rice straw, switchgrass, miscanthus and others have to be densified for reducing the handling, storage and transportation cost for production of ethanol or other kinds of biomass derived fuels at low cost in the future. Pelleting and cubing are two prominent existing technologies used for the densification of lignocellulosic biomass.

The pelleting and cubing process starts with the drying of biomass to required moisture content followed by sizing. Drying and sizing are two high energy consumption processes. Sizing requirements for these two processes vary. For small pellets, the biomass must be ground to small particles that are then reconstituted in the pellet mill. Most existing cubers/briquetters are used to make cubes of size less than 3″. For cubing lignocellulosic materials must be reduced in size to about twice the width of a cube. Therefore, in both processes, the basic biomass structure is broken down so that air can be expelled and a high density form can be achieved in the compaction step. In breaking the material down, any benefit of the original biomass structural integrity is lost, and this has to be replaced by adding a binder to hold the biomass particles together once they are forced out of the die by high pressure. Table 1 compares the mechanical energy requirement for compressing the biomass in pelleting and cubing processes. In addition a lot of heat energy is required for activating the inherent binder or externally added binder. In typical pelleting and cubing operations, the inherent lignin is activated by frictional heating with the die of the biomass to greater than 70 C, where lignin binding properties are good. Frictional heating is wasteful, since the expensive electric power driving the machine is the source of heat. Therefore, these processes are high energy consuming processes, which result in high production costs for densified biomass.

TABLE 1
Energy requirement for pelleting and cubing process

| Item | Cubing | Pelleting |
|---|---|---|
| Pressure, psi | 6,000 to 10,000 | 10,000 |
| Density, lb/cf | 25 to 35 | 50 |
| Energy source | Electrical | Electrical |
| Total energy requirement, kwh/ton | 50.63 | 53.90 |

In addition, in both pelleting and cubing processes, all the material is heated and the temperature is raised to above 70° C. for effective binding of the biomass. This excessive energy to heat all of the material further increases the production cost of densified biomass. In both pelleting and cubing operations the densified biomass exits from the equipment at a higher temperature and hence external forced cooling is used to cool the densified material and set the binder, which is very critical for increased strength and durability. This forced external cooling further increases the cost of production of densified material. Furthermore, since cooling and setting of the binder occurs after discharge of the material from the machine, the material can springback or lose some densification in the cooling process. In this case, some of the value of the initial densification is lost.

There is a continuing need to reduce energy, storage and transportation costs associated with the utilization of material and in particular biomass material such as lignocellulosic biomass material.

### SUMMARY OF THE INVENTION

In response to this need, a novel process and apparatus for densification of material, such as lignocellulosic biomass material has been defined and developed. The process is flexible in that it can be easily adapted to densify a range of materials that have either an inherent or added binder that is activated by heat. Examples of such material include lignocellulosic materials that consist of fibrous materials with lignin that can be used to bind the fibrous material together into logs, or densified structures. Materials that have been densified include corn stover, wheat straw, rice straw, switchgrass, miscanthus and alfalfa. In all cases, these fibrous materials were densified at up to 50 lb/cf, starting from <10 lb/cf raw material. Similar results are expected for many other lignocellulosic materials, such as wood residues, forest harvesting residues, tree trimmings and yard waste. While the raw material can be used without additional sizing beyond that produced by field harvesting equipment, the process may also be used with sized material of various scales down to fine particles. Depending on the lignocellulosic material being densified, the flexible process according to the invention requires little more than adjustments to pressure, heating time, temperature and cooling time to obtain optimal results.

In addition to lignocellulosic materials, the invention provides a process that can be used to densify materials that contain only minor amounts, or do not contain lignin. Examples include cardboard, paper, municipal solid waste, cellular plastic material residues and cellular inorganic materials and like materials. To bind these materials a heat activated binder needs to be added in sufficient quantities to yield the required strength and durability for the densified product. The added binder could be lignin based, or a hydrocarbon-based material that has the needed binding at the desired activation temperature. While the lignocellulosic materials typically experience binding activation at approximately 70 C, the added binder activation temperature could be different. In addition and owing to the flexibility of the process according to the invention, the compaction pressure and residence time at pressure, heating and cooling may be adjusted to yield optimal results.

According to some embodiments, a process and apparatus for densification of biomass material (a) requires no preprocessing such as drying and size reduction; (b) in the case of lignocellulosic material takes advantage of an inherent shear, tensile and/or compressive strength in the compacted material to provide structural integrity; (c) requires only moderate mechanical energy (as compared to pelleting or cubing) to remove air spaces inside and between the material during compaction; (d) uses external heat to activate binder, rather than heat energy generated from mechanical work; and (e) requires heating only near the surface to activate binder in a thick enough surface layer to encase the material with sufficient strength to maintain densification and resist handling, storage and transport stresses without degradation and (f) requires cooling only near the surface of the compacted product for setting binder and producing a densified product with the sufficient structural strength and/or integrity for storage and transportation requirements.

According to a preferred embodiment, lignocellulosic biomass is compressed into durable logs. The biomass may arrive at a compactor (according to the invention) in the form of bales, or other portions of biomass. The material is initially available on fields at a density of about 1-2 lbs/cf. In many cases, it is then compressed to any required format having approximately 10-15 lbs/cf using a baler or any other equipment. According to the preferred embodiment, the biomass is then compressed into logs of density between about 30 to 60 lbs/cf for reducing the storage, handling and transportation cost. In this process, there is no size reduction or drying necessary for making logs. Unlike pellets and cubes, durable densified logs of size ranging from 6″ to 15″ in diameter having densities ranging from 30 lbs/cf to 60 lbs/cf can be produced. In other embodiments log sizes and/or densities can be greater or less than the values given, depending on need.

Logs produced in accordance with one aspect of the invention are larger than pellets and have lower surface area per volume than pellets. As such, logs produced in accordance with this aspect of the invention are far less dependent on frictional effects, or mechanical work done on the material to raise the temperature, which correspondingly lowers power requirements for log making. Heating is used as a replacement for mechanical work, with the overall energy cost for densification of material into logs being substantially lower than pelleting. The high cost of electric power heating (or mechanical working of material) is replaced by a much lower cost of heat provided by biomass or other low cost fuel combustion.

According to another aspect of the invention a densified biomass material is produced that has a protective shell along the periphery of the material. The shell is formed by heat activated binder material that may be added to, or inherent in the material. The shell of strengthening binder material is formed by heating the compacted biomass material (to activate the binder) then cooling while the biomass material is held in its compacted state (setting the binder). By heating and cooling, essentially only the outer periphery of the biomass material, less energy is needed for densification and without compromising density and/or reduced volume, strength and structural integrity of the resultant product of densification.

According to another aspect of the invention, there is a densified product of a process for making densified lignocellulosic biomass material. The densified product is a log that is relatively large (as compared to pelleting or cubing) and that derives its structural integrity from an encapsulating shell of set binder material and the fibrous nature of the material forming the core of the log.

According to the another aspect of the invention, compaction and heating times or phases are adjusted or varied depending on the material type and binder properties. In one respect a compression and heating zone are de-coupled from each other, i.e., occurring at separate times and/or places, to simplify control over the process or reduce overall complexity. Or these zones may be de-coupled for purposes of maximizing throughput such as when a heat activation time for the binder is much higher than the time needed to compress the material in a controlled manner.

According to another aspect of invention, densification equipment for performing one or more of the aforementioned processes makes densified logs of 11″ diameter having density ranging from 30 lb/cf to 60 lbs/cf. The main parts of the equipment may include a feeding section, heating section, cooling section, pusher or piston, and gate. A hydraulic circuit may be used to operate a door of the feeding section, gate and pusher. A system of circulated oil may be used to activate binder (heat) and set binder (cool) for purposes of forming stable logs in a low-energy manner.

According to one embodiment, stable logs are produced in the following steps:
1. At the start, the door of the feeding section is open and the gate is closed.
2. Bales having density of about 10 lb/cf are discharged from a conveyor into the feeding section.
3. The door of the feeding section closes and may modestly compress the bale into the needed cylindrical shape ahead of primary compaction.
4. A heated piston ram/pusher is actuated and moves the bale into the heated zone and compresses the biomass to a preset density level of about 40 lb/cf against the gate and the compacted biomass is preheated for about 15 seconds.
5. After preheating the gate is lifted and the log is moved into the main heating section for activation of inherent binder in the periphery of compressed mass. The heating section can accommodate >4 logs which will increase the binder activation time to 5× preheating time.
6. As compressed biomass enters the main heating section, one log moves in to the cooling section.
7. Through the length of multiple logs in the cooling section, the compressed biomass is cooled to form stable logs. Also, the movement of a new log into the cooling tube forces out a log at the discharge end.

A compactor according to another aspect of invention is configured to accept baled formats of material including lignocellulosic material, utilizes a continuous heating and cooling section, uses a variable load and speed compacting piston for minimal energy consumption, and operates a heated gate for compaction of material. The gate may include internal oil flow lines and may be fitted with Teflon coating for friction reduction. The compactor may utilize circumferential flow of oil for increasing the velocity of oil flow for rapid heat transfer. The compression section may include tie rods for increasing the life of the compression and feeding section.

### INCORPORATION BY REFERENCE

All publications and patent applications mentioned in this specification are herein incorporated by reference to the same extent as if each individual publication or patent application was specifically and individually indicated to be incorporated by reference. To the extent there are any inconsistent usages of words and/or phrases between an incorporated publication or patent and the present specification, these words and/or phrases will have a meaning that is consistent with the manner in which they are used in the present specification.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIGS. 1-2 are first and second views of a compactor for densification of biomass material.

FIG. 3 is a first cross-sectional side view of the compactor showing a bale of biomass material being loaded into a receiving section of the compactor.

FIG. 4 is a second cross-sectional side view of the compactor showing a door or bale press being closed, in preparation for a compression of the biomass material.

FIG. 5 is a third cross-sectional side view of the compactor showing a compression of the material into a log.

FIG. 6 is a fourth cross-sectional side view of the compactor showing the formed log being moved into a downstream heating section of a barrel of the compactor.

FIG. 7 is a fifth cross-sectional side view of the compactor showing the loading of a second bale into the compactor.

FIGS. 8A-8D show flow processes for densification of biomass material according to the disclosure.

FIGS. 9A and 9B are isometric and cross-sectional views, respectively, of a switchgrass log made in accordance with the disclosure.

FIG. 10 is a plot showing temperature profile verses depth during heating and cooling of logs constructed in accordance with the disclosure.

FIG. 11 is a plot showing a theoretically determined temperature profile inside a log during a densification process.

FIG. 12 shows the cooling load needed for a log.

FIG. 13 plots capacity verses process time.

FIG. 14 plots density of logs versus process time.

### DETAILED DESCRIPTION OF EMBODIMENTS

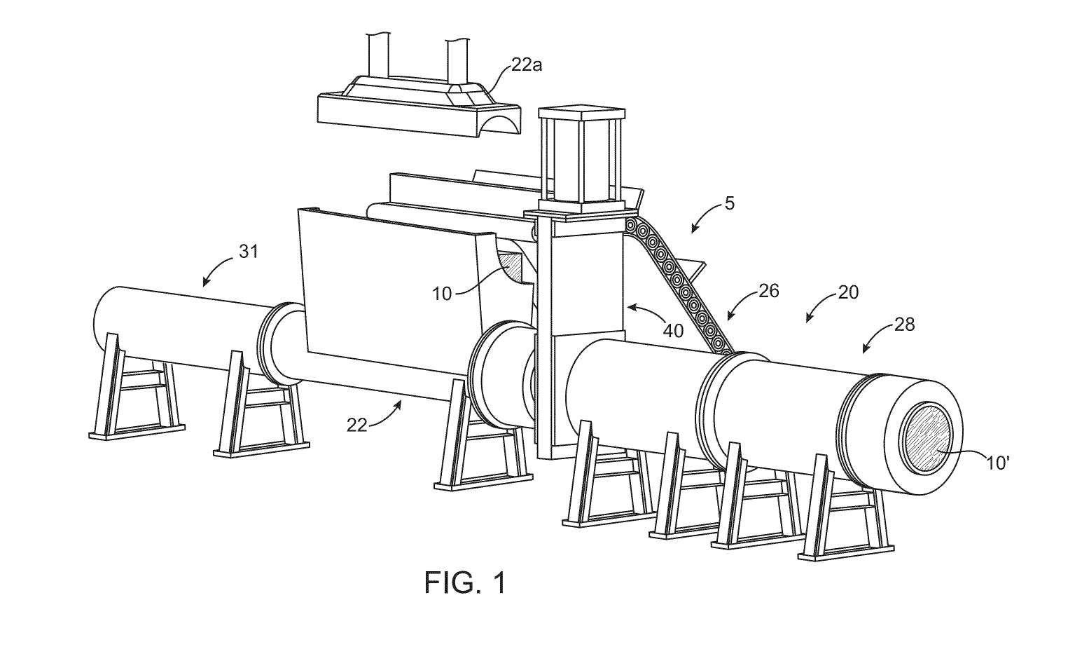

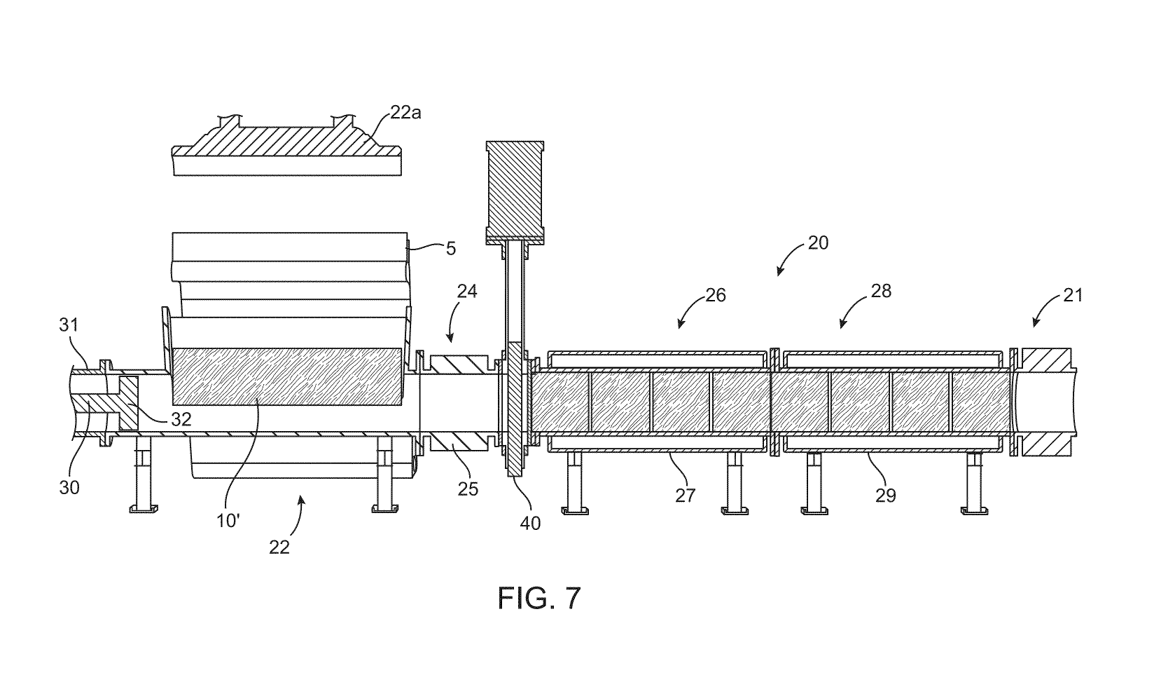

The discussion proceeds as follows. Preferred embodiments of a system and process for densification of biomass material are discussed first with reference to FIGS. 1-7. Next, laboratory experiments are discussed. These experiments were done to make preliminary estimates of process parameters, such as heating and cooling times, for logs. Next discussed is a full-scale field test of a compactor for biomass material. From the field test conclusions are reached regarding the various parameters associated with the densification process and modifications, types of material, etc.

FIGS. 1-7 depict a compactor and steps associated with the densification of a lignocellulosic biomass material according to the disclosure. The compactor receives the lignocellulosic biomass material in the form of a bale and converts the bale into a compacted, densified form which, for the sake of convenience shall be called a log. The term “log” is not intended to be limiting as to its final form. Rather, a log is simply intended to mean the densified product of a densification process according to the disclosure. According to one embodiment, for a 30-second initial compaction time of the biomass material, throughput for the compactor can be varied from 1 to 4 tons per hour (TPH).

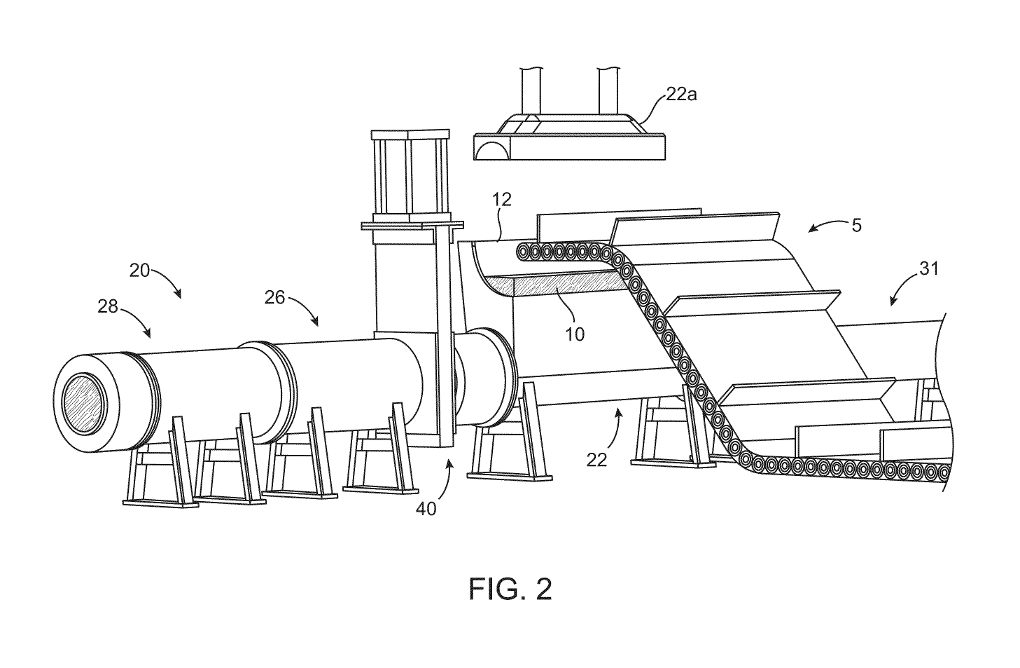

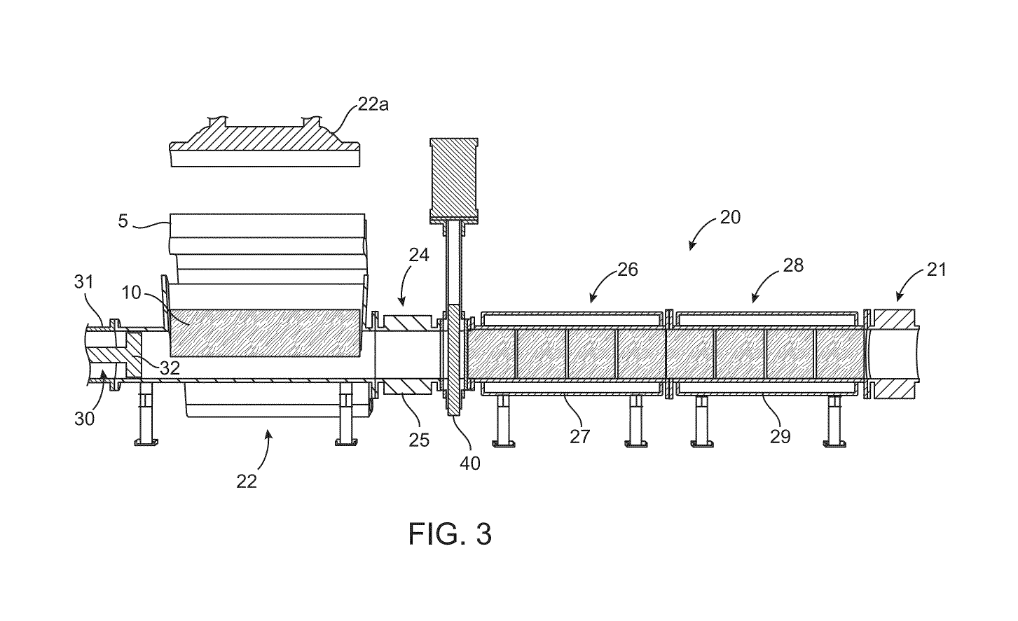

Operation of the compactor proceeds via the following steps, as illustrated in FIGS. 3-7. Referring, first, to FIGS. 1-2, a bale 10 (e.g. 12″×12″×48″ and 10 lb/cf density) rides a conveyor 5 that loads the bale 10 into a hopper 12 aligned with an opening in a barrel 20 of the compactor (FIG. 3). The compactor barrel 20 has a receiving section 22, compression and heating section 24, heating section 26, cooling section 28 and constrictor section 21.

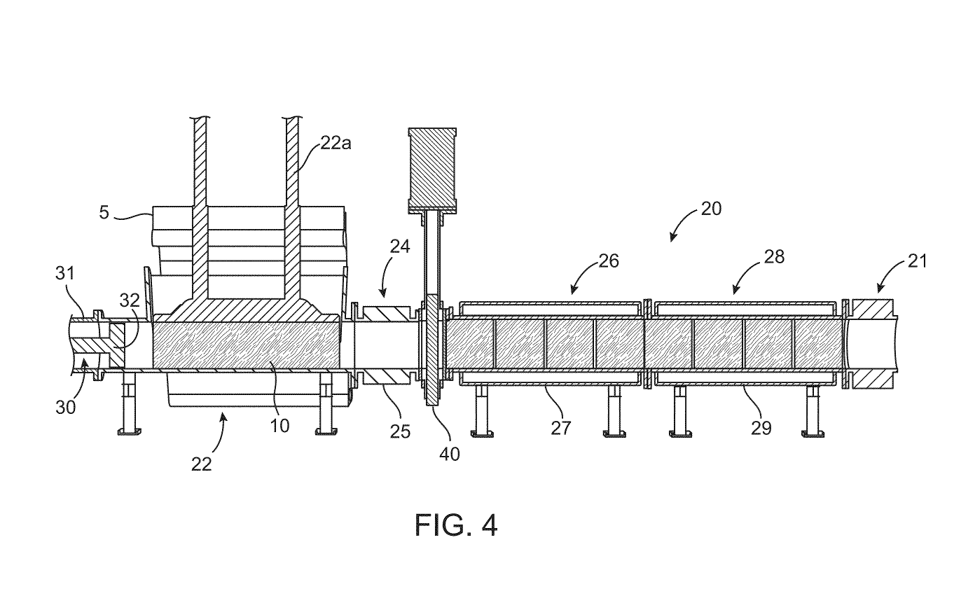

The bale 10 enters the barrel 20 at the receiving section 22. A bale press 22a (or hinged door) moves downward or closes to modestly compress the bale 10 into a cylindrical shape ahead of primary compaction, which occurs at the compression section 24 (FIG. 4).

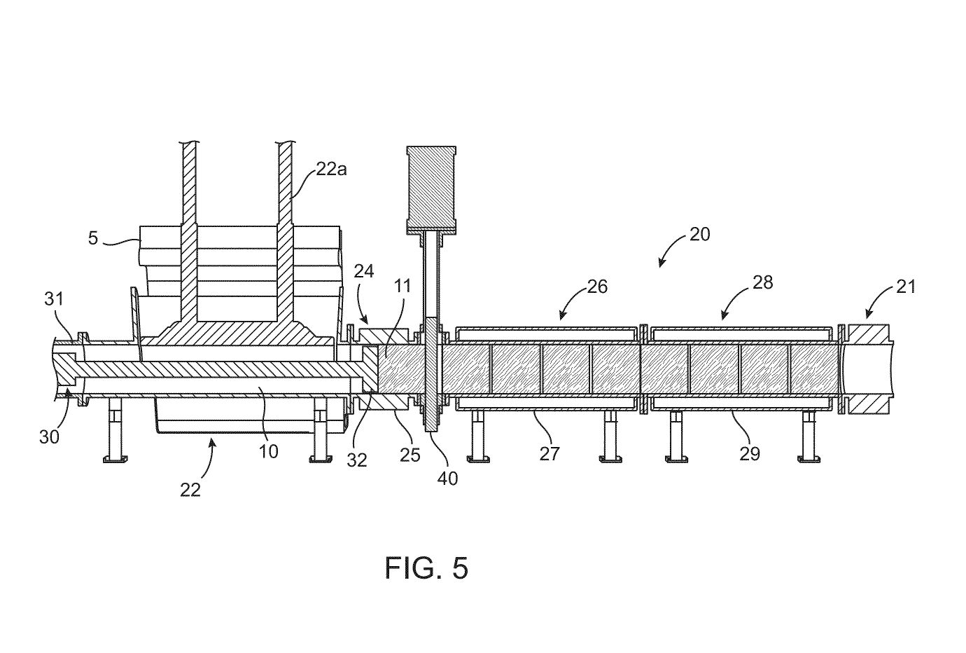

Located to the left end of the receiving section 22 is a cylinder 31 that holds a heated piston ram 30 for compressing the bale 10. The piston ram 30 is actuated and moves the bale 10 into the compaction section 24 where the bale 10 is then compressed between the heated head 32 of the piston ram 30 and a heated barrier gate 40 which is located at the right hand side of the compression section 24. The bale 10 is compressed into a log 11 having density of about 40 lb/cf (FIG. 5). The compression section 24 walls are heated by a jacket 25 containing circulating oil to soften the biomass material and/or start activating binder.

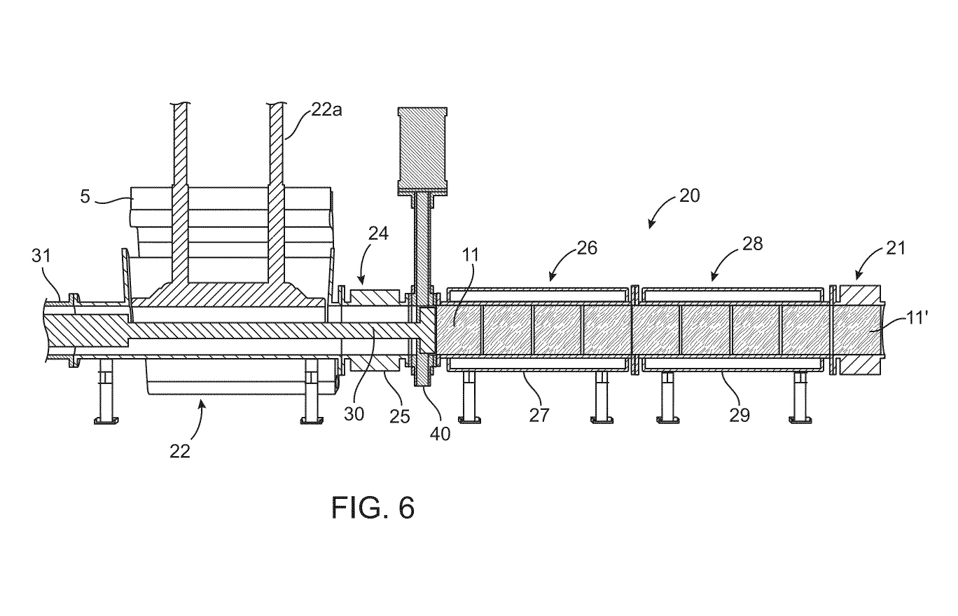

After compaction, the barrier gate 40 is lifted and the log 11 is moved forward against earlier compacted logs located in the downstream heating section 26 and cooling section 28 of the barrel 20 (eight such logs are shown). The heating section has walls heated by a jacket 27 containing circulating hot oil. The cooling section may have radiating fins or the like for passive cooling, or have a jacket 29 containing a circulating oil for dissipating heat. Through the length of the multiple logs in these heating and cooling zones, respectively, of the compactor the logs are maintained in a compressed state. Movement of log 11 into the heating section 26 by the actuated piston ram 30 forces a log 11′ out of the barrel 20 at the discharge end 21 (FIG. 6). The piston ram 30 is retracted and the barrier gate 40 closed to restart the compaction process.

The log 11 periphery is heated further in the heating section 26 under the compressed state in the barrel 20 until the heat activated binder is heated to the needed temperature at the needed depth. At the same time, the bale press 22a is lifted and the next bale 10′ is dropped into the receiving section 22 by the conveyor 5. The same process is repeated for the bale 10′.

As later logs are pushed downstream the log 11 is eventually moved beyond the heating section 26 and into the cooling section 28, where the log 11 periphery is cooled to the needed depth to set the binder and prevent loss of compaction after the log is discharged from the end 21 of the compactor.

The heating of the logs may occur at different stages along the barrel 20, and/or in different ways during the process depending on the biomass material and needed binder activation to provide structural integrity to the log.

Mode 1: heating is done only to the left of the gate 40 (ends and sides heated) so that both compaction and heating occur at the compaction section 24 (field tests were conducted using this arrangement). Heating during the compaction phase softens the biomass material to make compaction less dissipative, but the added heating time can limit throughput. This mode of heating and compaction may be preferred for binders that require similar heating time to the compaction time.

Mode 2: some heating is done to the left of the gate 40 and more to the right of the gate 40 (side heated). This mode is preferred for binders that require more heating than compaction time. Mode 2 yields some beneficial softening and decouples heating time from compaction time, which maximizes throughput for those binders that require more heating than compaction time. For example, for an arrangement of four logs to the right of the gate 40 and located in the heating section 26 zone before the next log is pushed beyond the gate 40 (as shown), the heating time would be four times the compaction timescale for the material. It is desirable to limit heat to the periphery of the log, particularly in the right of the gate 40 as this limits the cooling time needed to set the binder.

Mode 3: log heating occurs only to the right of the gate 40 in the heating section 26, for decoupling the compaction from the heating time (sides-only are heated). This mode may be preferred as it is simpler to control the heat added to the log than mode 2, but it only heats the cylindrical periphery, and thereby has less binding on the log faces. This may be acceptable for some material.

Mode 4: log heating occurs at the end faces of the log to the left of the gate 40, and sides are heated only to the right of the gate 40 in the heating section 26.

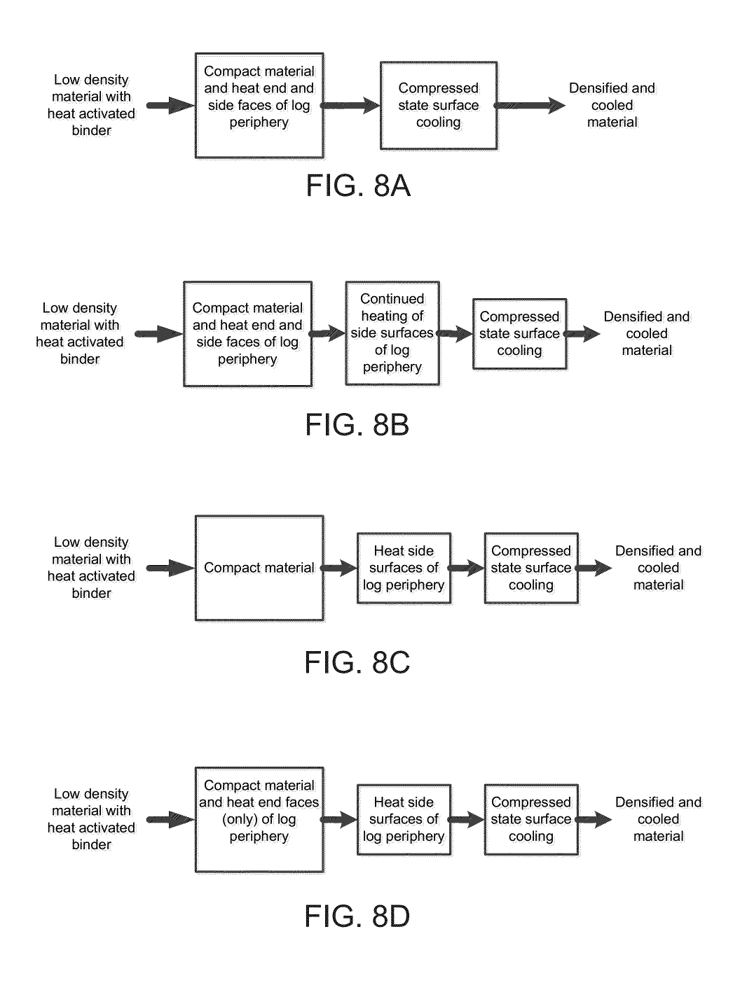

FIGS. 8A-8D provides flow charts summarizing Modes 1-4. The low density material is preferably lignocellulosic biomass material, but it need not be limited to lignocellulosic or even biomass material. In addition to lignocellulosic materials, these processes may be adapted to densify material that contains only minor amounts, or do not contain, lignin. Examples include cardboard, paper, municipal solid waste, cellular plastic material residues, cellular inorganic materials and like materials. To bind these materials a heat activated binder is added in sufficient quantities to yield the required strength and durability for the densified product. The added binder could be lignin based, or a hydrocarbon-based material that has the needed binding at the desired activation temperature. While the lignocellulosic materials experience binding activation at approximately 70 C, the added binder activation temperature could be different. In addition and owing to the flexibility of the process, the compaction pressure and residence time at pressure, heating and cooling may be adjusted to yield optimal results, as will be further appreciated in view of the discussion that follows.

As will also be appreciated, through repetition of the above process, logs may be produced at a needed rate with a very modest amount of mechanical work needed, i.e., mostly the work done by the piston head 32. The piston axially compresses the material in a single motion, and then pushes logs along the barrel 20 into heating and cooling areas using this same motion. As earlier processed logs are cooled to set binder, upstream bales are heated to activate binder. When a new bale is added, the piston pushes everything further along the barrel 20 until they eventually exit the barrel as finished logs with set binder. Thus, the process, by design, requires only a very modest amount of mechanical/electrical energy. As explained in greater detail, below, there is also a relatively low amount of energy needed to heat and cool logs as compared to the mechanical energy expanded in prior art pelleting and cubing processes.

Ram forces for the piston head 32 (for compressing the material) may be produced by a high pressure cylinder fed by a positive displacement hydraulic fluid pump. Moreover, the head 32 hydraulic force, and hydraulic forces for activating the gate 40 and door 22a may be controlled through a single hydraulic circuit. The walls of the heating section 26 (and, optionally, the walls of the compression section 24), head 32 and face of the gate 40 may be heated using a hot oil system fired by low-cost biomass in the production system. Thermal oils satisfying a 150 C maximum oil temperature requirement and having adequate flow rates at this temperature are readily available for providing sufficient heat transfer to surfaces of the compactor for binder activation. For cooling, a positive air flow over the cooling section 28 shell may be used to augment cooling produced by heat soaking into the log interior, thereby promoting evaporation of water. Sufficient vapor exit paths may be included over the cooling section 28 length to allow vapor to escape while still retaining the solid material at the required compression level.

Air cooling may be used for cooling logs in the cooling section 28, although it is preferred to remove heat more quickly using a circulating fluid, such as a cooling oil. Air cooling may be used if the cooling section 28 is lengthened (or provided with increased surface area for radiating heat) so that a log is sufficiently cooled to set binder before being discharged from the channel 20. Preferably, an oil cooled jacket fitted around the cylindrical cooling section 28 to extract heat. The oil flows through a radiator where a fan cools the circulating oil. This system may be designed to yield any needed cooling requirement.

Testing

Experiments were conducted to define heating and cooling requirements for a production-scale system described in FIGS. 1-7. These tests were conducted with the aid of the test apparatus scaled-down experimental compactor. The test equipment included a press frame, hydraulic press, feeding cylinder (receiving the biomass material), and first and second compression dies.

A biomass material (switchgrass) was loaded into the first compression die and compacted using the hydraulic press. The compacted material was then placed in the second compression die and pressed again using the hydraulic press. As the switchgrass is pressed in the second die, it is heated to the required temperature using band heaters. The temperature is controlled through a rheostat and is measured by a thermocouple. As the temperature of switchgrass reaches the required level, heating is stopped and the switchgrass is cooled using a fan mounted on the press frame. Once cooled to the required level, the switchgrass is expelled from the second die as a switchgrass log.

In contrast to a pelleting or cubing operation, the switchgrass was not sized ahead of compaction. The initial moisture content of the switchgrass was found to be 12%, using the ASABE standard procedure. To increase the moisture content to 15% and 30%, a known quantity of switchgrass and moisture was transferred to a polyethylene bag, stored overnight and used in the experiments. The log formation process was then followed with the high moisture content switchgrass. Test results using the higher moisture-content switchgrass suggest that moisture content below about 20% are best for making logs.

Higher compaction pressures are naturally expected to yield higher density logs. However, to maintain high density upon release from a die, the inherent lignin binder had to be activated. This typically occurs at temperatures above 70 C, for all lignocellulosic materials. After activating the binder, the material (compressed within the die) is cooled down to the point where the binder solidifies. After a sufficient period of solidification within the die, the log is ejected from the die. Cooling down to room temperature certainly works, but it adds more time to the process and reduces throughput. For maximizing throughput, a cool-down temperature limit greater than room temperature is desired.

Tests were also conducted with a second stage compaction pressure set at 650 psi and a biomass peak temperature at the periphery of the log set to 100 C. Given that the die heats the log from the outside, the interior of the log was probably much less than 100 C. Once the periphery temperature reached 100 C, the die heater was shut off and the die cooled by the fan. Once the log temperature reached the target cool-down temperature, the log was ejected from the die and the density measured. For conditions where the cool-down temperature was too high and the binder had not solidified, the log would experience spring-back and the density would decrease. For the case where the binder did reach a solid and strong condition, the log did not spring-back, and density was higher. Several tests duplicated this behavior at the 650 psi pressure level. Log densities for the 650 psi compaction pressure and 100 C maximum temperature, with cool-down temperatures of 50 C and 45 C were compared. The lower cool-down temperature yields less spring-back and a higher density. With the 45 C temperature the density is 13% higher than the 50 C cool-down temperature case. Log densities for a 750 psi compaction pressure and 100 C maximum temperature, with cool-down temperatures from 55 C to 40 C were also compared. Reducing the cool-down temperature increases the density as a result of reducing spring-back upon log release from the die. In addition, at the higher compaction pressure, the log density exceeds 30 lb/cf.

When increasing the pressure from 300 psi to 900 psi, at 100 C maximum temperature and an acceptable cool-down temperature, log density increased from about 20 lb/cf to nearly 40 lb/cf. As compared to a conventional pelletization process, it was found that these densities were achieved using a much lower pressure and power. This reveals that densification costs for a lignocellulosic material using compression and heating should be significantly less than when using a pelletization process. In addition, the results were achieved without added binder and added cost.

Tests were also conducted on the activated binder, which occurs mostly along the outer surface of the log. Activation of binder in the material along the outer surface, rather than throughout the material, reduces energy costs. With this objective in mind, the process seeks to limit use of binder to a log's periphery, which can provide strength to the log in the form of a shell that encapsulates the log. Shell strength is much more important to log integrity than core strength. Essentially, by producing a strong shell, the bulk biomass may have the necessary strength and weather resistance. In support of this objective, tests were conducted to determine the ranges of minimal thermal energy input to the log that would be needed to activate binder at the log's periphery to form the shell.

The wall temperature of the compression die was maintained at either 150° C. or 175° C., before the biomass was compressed. Top and bottom plates used for compressing the biomass (the top plate being connected to the hydraulic press) were also heated to the same temperature along with die section. For thermal activation of the inherent binder, the biomass was heated for a specified time under compression. For setting of the binder, the log was pushed into a downstream cooling section, where the die was maintained at room temperature. A fan was used to dissipate heat in the log in the cooling section. After cooling, the formed log was pushed out of die. In the initial tests, the bottom plate and top plate were placed in contact with the biomass for the entire period of both thermal activation and setting. In contrast, the sides were in contact with a cool cylinder during the cool down stage. Because the top and bottom of the log was not cooled during the “cool down” stage, the binding on the top and bottom of the logs was poor. To correct this problem, the top and bottom plates were removed immediately after completion of heating, and new cold plates were inserted on the top and bottom of the log to achieve proper cooling when the log was pushed beyond the heated die section into the cool down section. The integrity of logs was measured in terms of the final relaxed density of the log, compressive strength and drop strength under shock loads. The logs produced at pressures of 600 and 900 psi had very good compressive strength, as well as drop strength.

The density (or specific weight) of logs is measured as the ratio of weight to volume of the log. The volume of logs was measured by considering the logs as cylinders. All the density measurements were made after cooling the logs to room temperature and allowing for any spring back or recoil. Hence, the measured densities are a relaxed density of logs. The measured density of cylindrical logs when heating only one end and the round sides is shown in TABLE 1. Densities for logs heated on all sides are shown in TABLE 2.

TABLE 1
Log densities (heated on only one side).

| SI. No. | Pressure, psi | Temperature ° C. | Density, lb/ft³ |
|---|---|---|---|
| 1 | 300 | 175 | 31.6 |
| 2 | 650 | 175 | 37.4 |
| 3 | 900 | 175 | 41.1 |
| 4 | 300 | 150 | 29.6 |
| 5 | 650 | 150 | 34.3 |
| 6 | 900 | 150 | 38.8 |

TABLE 2
Log densities (heated on both sides).

| SI. No. | Pressure, psi | Temperature ° C. | Density, lb/ft³ |
|---|---|---|---|
| 1 | 300 | 175 | 31.7 |
| 2 | 650 | 175 | 37.7 |
| 3 | 900 | 175 | 42.6 |
| 4 | 300 | 150 | 29.8 |
| 5 | 650 | 150 | 34.5 |
| 6 | 900 | 150 | 38.8 |

From these it is believed that good quality logs can be produced using pressures as low as 300 psi when binder is activated on all sides of the log. The logs produced at a pressure of 300 psi have good compressive strength, and sufficient drop strength. But the final density of logs produced at 300 psi is in the range of 29 to 31 lb/cf, which is less than the 40 lb/cf density produced at higher pressures. Low pressure compaction also makes the log more susceptible to crack formation, which leads to logs that are not straight cylinders. Most of the logs produced at a pressure of 300 psi were slightly bent from the point where cracks were observed.

In sum, the density of logs formed by activation of binder on the top and bottom surfaces of the logs and sides was much higher than logs without activation on both the top and bottom end surfaces. The logs produced with a pressure of 300 psi, without activation on the top and bottom, was around 20 lbs/cf. But the density of logs produced by activation of binder on both sides of the log was found to be around 30 lbs/cf at a compressive pressure of 300 psi. In comparison, the density of logs produced at a pressure of 900 psi, without activation of binder on the top and bottom surfaces, was around 30 lbs/cf. The density of logs produced by activation of binder on the top and bottom surfaces at 900 psi was around 40 lbs/cf. These results clearly show the density benefits of activation of binder on the top and bottom of logs. By binder activation on all surfaces, logs will have better density and improved handling characteristics, as noted below.

The compressive strength of logs was measured by inserting a load cell in the compression testing equipment to determine log compressive force. An Omega model load cell, having a capacity of 50,000 lbs, was used to measure the log compressive strength. The load cell was fixed between the compression rod and the bottom frame of the press. Logs were placed in such a way that the radial direction aligns with the direction of compression. When compressing the logs in the radial direction, the recorded resistance force was found to increase continuously, reach a maximum value and then start to decrease. The maximum force during the compression of logs in the radial direction was recorded as the compressive strength of logs. In this case, the crushed log has an oval cross section. The measured compressive strength of logs formed by heating on one side and both sides (top and bottom) are shown TABLE 3 and TABLE 4, respectively.

TABLE 3
Compressive strength of logs (activation
of binder on only one side)

| SI. No. | Pressure, psi | Temperature, ° C. | Compressive strength, lbs |
|---|---|---|---|
| 1 | 300 | 175 | 600 |
| 2 | 650 | 175 | 720 |
| 3 | 900 | 175 | 750 |
| 4 | 300 | 150 | 600 |
| 5 | 650 | 150 | 680 |
| 6 | 900 | 150 | 700 |

TABLE 4
Compressive strength of logs (activation of binder on both sides)

| SI. No | Pressure, psi | Temperature, ° C. | Compressive strength, lbs |
|---|---|---|---|
| 1 | 300 | 175 | 650 |
| 2 | 650 | 175 | 720 |
| 3 | 900 | 175 | 780 |
| 4 | 300 | 150 | 620 |
| 5 | 650 | 150 | 680 |
| 6 | 900 | 150 | 710 |

During tests reported on previously, it was found that the compressive strength of logs was in the range of 500 lbs for logs produced with binder activation only on the side of the logs. In comparison, the compressive strength was increased for logs produced by heating the top or bottom of logs, as well as the sides. The compressive strength of logs produced with 900 psi pressure and activation of binder on the top and bottom log surfaces was around 750 lbs, which is 50% higher than the logs produced with the same production conditions, but with activation of binder only on the cylindrical surface. However, the difference in compressive strength of logs produced by activation of binder on only one side and activation of binder on both sides was similar, as can be seen by comparing results in TABLES 3 and 4.

Log drop strength is measured by dropping the log from a height of 10 feet onto a concrete surface. During drop tests, it was observed that the logs do not disintegrate or break into pieces after many drops. This is due to the strength of binder as well as the configuration of raw switchgrass used for the production of logs. Since the switchgrass was used without sizing, long stalks of the grass were contained within the logs and this material tended to add significant strength to the log. Essentially, the log consisted of stalks that have strength that are “glued” together by the binder, somewhat like a composite material (e.g. fiberglass) construction. In contrast, if the switchgrass was ground to a fine dust and compacted with binder, it would lose this composite strength. Also, any breakage would result in the release of dust that could be a nuisance. During the drop tests it was observed that the logs did not disintegrate even after many drops. The drop strength is defined as the number of drops after which the log becomes more flexible and weight is reduced by approximately 10%.

During drop testing it was found that the logs, formed by heating both ends of the log, were very stable and intact even after 20 drops onto a cement surface from a height of 10 feet. No breakage or loosening of logs was observed. But for logs where only one end was heated, the untreated end was found to loosen after 15 continuous drops onto a cement surface. Nevertheless, no log chipping or breakage was observed. Logs made without treating the ends were found to be stable up to 12 drops, and began to loosen a little bit. After 15 drops, some of the log ends chipped, depending on the filling method during log making process.

In summary, the static compressive and dynamic drop tests showed that logs heated on all sides to activate binder are robust and very stable and probably can be readily handled using bulk handling equipment. Even cases where only the sides were heated performed well. However, heating all sides showed substantial increases of compressive loading capability and an increase in resistance to breakage during drop tests.

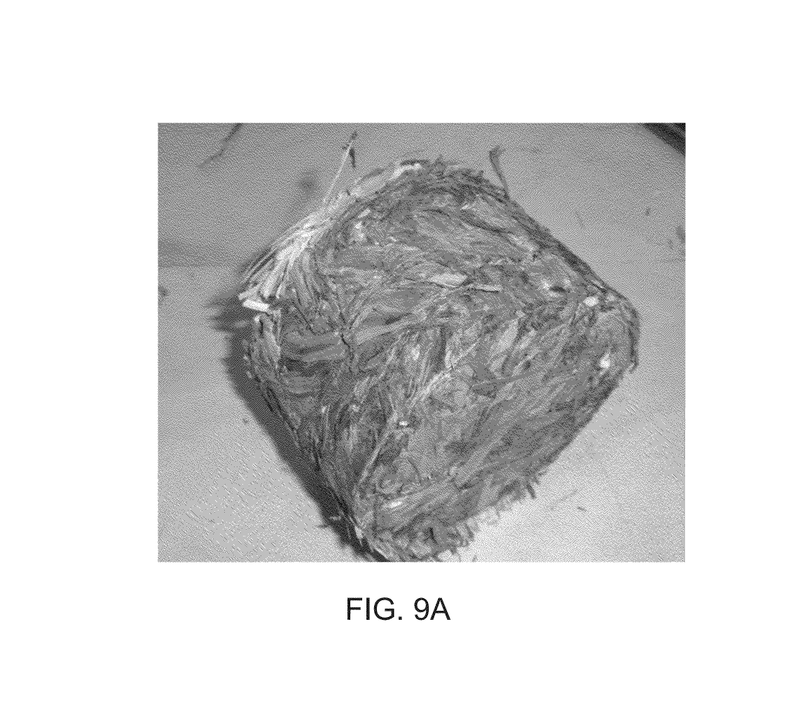

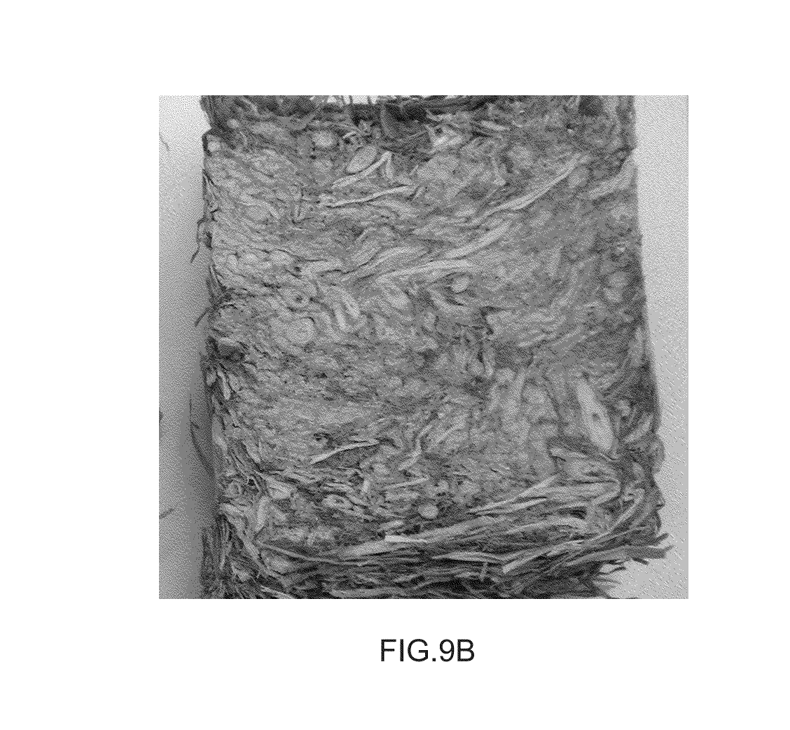

A switchgrass log produced during testing is shown in FIG. 9A. A similarly-made switchgrass log was cut in half to examine is cross-sectional characteristics. The cross-section of the log is shown in FIG. 9B. For this log the biomass was heated on the periphery of the log for a very short duration. But a close observation of the log shows good binding inside the log. The melting of natural binder components in the log occurs due to high temperature as well as pressure. Even though the inside temperature is below the glass transition point of lignin, good binding was observed inside the logs, potentially due to the migration of active binder.

For purposes of understanding the heat transfer characteristics of a log during the compression, heating and cooling phases of the densification process, thermocouples were located at varies places on and within the biomass. These temperatures were plotted verses time to better understand the changes in temperature occurring on and within the log. Additionally, detailed heat transfer analysis was carried out to determine the unsteady state heat transfer inside the compressed switchgrass. The thermal diffusivity is calculated using the temperature profile recorded during heating and cooling of logs. From the temperature profile over the total process time, the diffusivity is calculated, using the method described by Adams et al. (1976). The thermal diffusivity is given by the equation:

$$D = \frac{{( {z}_{2} - {z}_{1} )}^{2} π / P}{{[ ln ( {T}_{1} ) - ln ( {T}_{2} ) ]}^{2}}$$

Where D—Diffusivity
z₁ and z₂—Depth from surface
   T₁—Amplitude of temperature at depth z₁
   T₂—Amplitude of temperature at depth z₂
      P—Period of wave.

The average diffusivity calculated for switchgrass was found to be 3×10⁻⁴ m²/hr. It is also observed that as the pressure is increased, the diffusivity is slightly reduced. This parameter was then used in calculations of log heating and cooling for a larger scale field test equipment design, e.g., the system illustrated in FIGS. 1-7.

Heating System

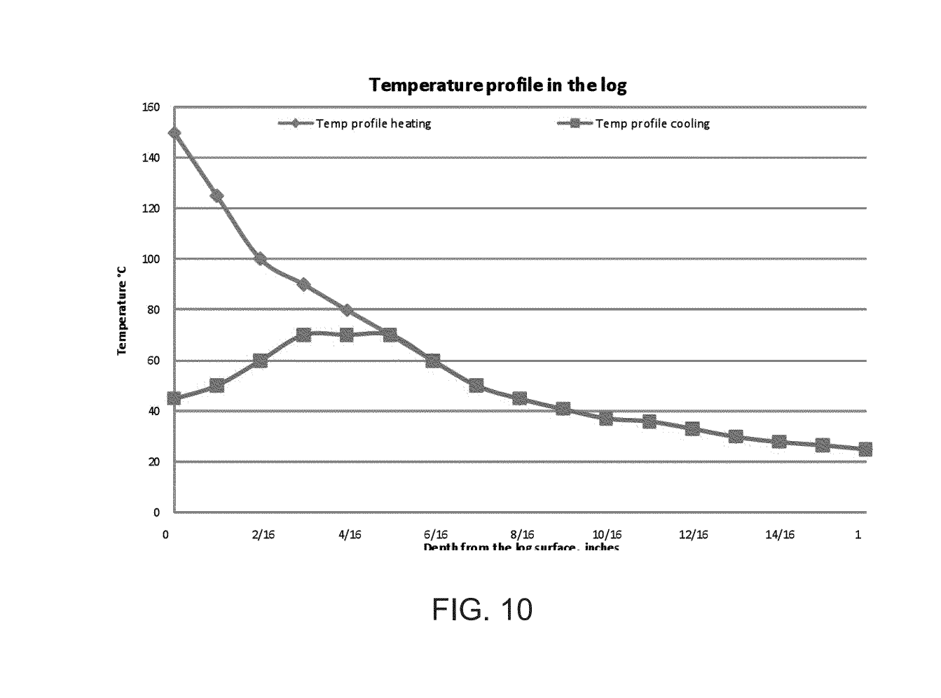

The total heat requirement for a demonstration scale log making machine (or compactor) was determined from the recorded temperature data at different depths collected in the lab testing equipment. A typical temperature profile inside the log during heating process is shown in FIG. 10, which plots temperature verses depth from the log surface. Based on the temperature data obtained from the test apparatus, the total heat requirement was determined. The biomass was considered to be a series of concentric annular cylinders having a thickness of ⅛″. Based on the temperature in these concentric annular cylinders, the total sensible heat and latent heat of vaporization of around 10% of water present in the biomass was added to get the total heat requirement. Based on experimental data, the heat requirement was 1100 Btu/min (˜20 kw).

Referring again to FIGS. 1-7, the heating section 24 and 26 of the barrel 20 are both formed as a jacketed cylindrical section and oil flows through the jacket (as noted earlier, the compression section 24 need not include a heating jacket, in which case only ends are heated during the compression step). The hot oil from the hot oil system runs through the jacket and heat is transferred from the oil to the biomass. Inside the jacket, circumferential channels are formed by rolling thin tubes over the inner cylinder. This forms circumferential oil flow lines in the heating section which increases the velocity of flow of oil inside the channel. This increased velocity effectively increases the heat transfer coefficient and the biomass is heated at much faster rates.

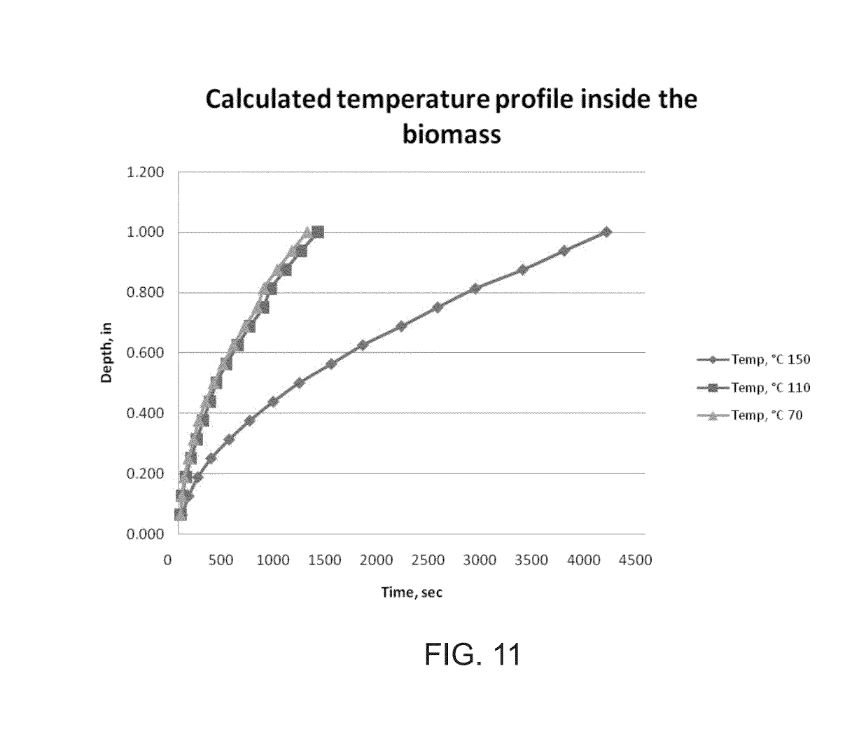

The diffusivity number calculated and noted above was used to determine the temperature profile inside the logs using unsteady state heat transfer analysis. A Heisler chart was used to determine the temperature profile inside the log using unsteady state analysis. The thin layer on the surface was considered as an infinite slab having a particular thickness. The Biot number (hL/K) was determined and used to determine the Fourier number at different temperature ratios. Based on the Fourier Number (at/L²) the time required to reach the predetermined temperatures of 70° C., 110° C. and 150° C. were determined and given in FIG. 11. These data were very close to the measured temperature profile inside the biomass during the heating process. Based on the calculated temperature profile, the time required to reach a temperature of 70° C. at a depth of ⅛″ is 28.4 sec. This then sets the heating time to reach binder activation within the ⅛-inch layer. After that time, the heating can be halted, but the heat will continue to migrate inward, heating deeper layers in the log to a lower than 70 C level.

Cooling System

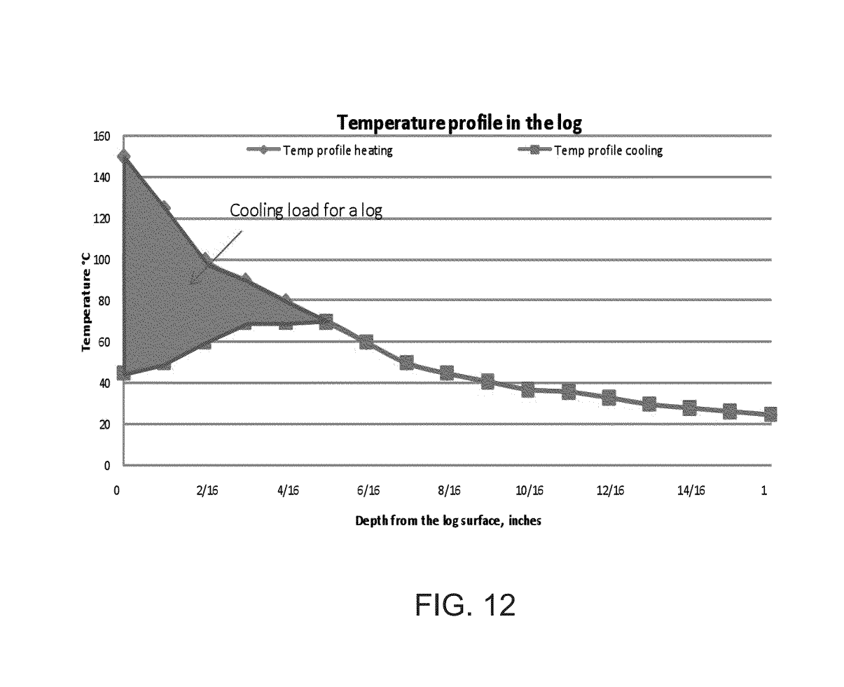

The cooling section 28 was designed as per the procedure followed in the heating system design. The measured temperature profile inside the log during cooling was given in FIG. 10. The temperature profile inside the log during testing was used to determine the cooling rate and cooling system capacity. During lab testing, it was determined that cooling the hot surface of the log to a temperature of 45° C. is sufficient to maintain the shape and density of logs. Continuing the cooling further does not significantly improve the density and other properties of the log, but the added cooling time adversely affects the capacity of the equipment. Hence equipment cooling load was determined based on the amount of heat to be removed for reducing the temperature profile during heating to the temperature profile during cooling as shown in FIG. 12. The heat removal rate from the biomass was determined to be 130 Btu/min (˜2.3 kw). Radiator-type cooling equipment having a cooling capacity of 3 kw may be used. The cooling oil circulating in the cooling section 28 cools the logs. The cooling section is a jacketed cylindrical section and oil flows through the jacket. Inside the jacket, oil circumferential channels are formed by rolling thin tubes over the inner cylinder. This forms circumferential oil flow lines in the cooling section which increases the velocity of flow of oil inside the channel, which effectively increases the heat transfer coefficient and heat removal rate.

Hydraulic System

The piston 30, door 22a and gate 40 may be actuated using a hydraulic circuit. During testing, it was observed that the compressive force needed for initial compression of switchgrass in the die was small. Maximum force is required only toward the end of compression. Hence in order to minimize power needs, the actuator for the piston 30 may be designed to work at three stages, using different operating conditions, as shown in TABLE 5.

TABLE 5
Operating conditions at different stages of compression piston

| | | | |
|---|---|---|---|
| | Length of | Forward | |
| Force | travel | Speed | Remarks |

Forward

| | | | |
|---|---|---|---|
| Low - 5000 lbs | 24″ (0-24″) | 5″/sec | Moving bale |
| Medium - 11,500 lbs | 14″ (24-38″) | 5″/sec | Low pressure |
| | | | compression |
| High - 100,000 lbs | 6″ (38-44″) | 0.12″/sec | High pressure |
| | | | compression |
| Medium - 11,500 lbs | 10″ (44-54″) | 5″/sec | Moving the log to |
| | | | cooling section |

Return

| | | | |
|---|---|---|---|
| No resistance | 54″ (54-0″) | ≧5″/sec | Return stroke |

Referring to the discussion earlier in connection with FIGS. 3-7, the operating sequence for the hydraulic system may be as follows. Initially, the piston 30 is fully retracted, the door 22a is open and gate 40 is closed. After the bale is received in the receiving section 22, the door or cover 22a closes (step 1) and the piston 30 pressure is increased to a level 1 which begins the compression of the biomass material (step 2). The piston 30 hydraulic pressure is increased to level 2 to increase the compression force on the biomass material (step 3). The log is formed. The gate 40 is lifted or opened (step 4). The piston 30 pressure is increased to level 3 to push the log into the heating section 26 (step 5). The piston 30 is retracted (step 6). The gate 40 closes (step 7) and the cover 22a opened to receive the next bale (step 8).

Testing of hydraulic, heating and cooling systems using field tests.

Field tests were conducted on a compactor like the one shown in FIGS. 1-7. The process used was that shown in FIG. 8A (heating and compression all occur at the same time, followed by cooling). During preliminary tests, it was observed that control of oil temperature, preheating time in the heating section, heating time in the fully compressed state, level of compression (compressed volume in the compression zone), cooling time, level of back pressure developed in the cooling section 28 and axial movement of the piston 30 beyond the gate 40 effects log quality and the amount of energy usage. Tests were conducted to assess the relative importance of controlling these operating conditions to arrive at the desired result. Tests were carried out to define operating conditions for producing good quality logs. Operating parameters, such as heating time, cooling time, level of compression and level of back pressure etc., were tested.

For testing, the system of FIGS. 1-7 included a heating jacket at only the compression section 24 and cooling in sections 26 and 28. Operating conditions may be determined from tests conducted using the test parameters.
1. Methods of loading: (a) Sized bale flakes, and (b) Direction of straw parallel and perpendicular to the direction of pressing.
2. Process time: 90 sec, 120 sec, 210 sec and 360 sec for log compression, heating and cooling.
3. Level of compression: 3″ and 4″ compressed state in front of gate 40.
4. Level of back pressure: push log 1″, 1½″ and 2″ beyond gate 40 to control spring-back during cooling.
5. Level of heating: 350° F. and 400° F. oil temperature.

The field test equipment was built with provision to measure oil temperature at the inlet and outlet of the heating section 24, gate 40, piston 30 and cooling section 28. Swagelok fittings were used to hold ⅛″ thermocouples. The temperature was measured using an OMEGA RD 9000 model paperless recorder, connected with the thermocouples on the test equipment.

The oil pressure in the hydraulic system was measured using a 0-3000 psi pressure gauge attached to the manifold. The pressure gauge was located directly in front of the operator or conveyor 5 feeding the biomass into the machine. The pressure at different conditions, such as beginning of compression, end of compression and during heating, were noted during testing. During log making, the piston 30 was stopped immediately after entering the compression section 24. The biomass was pre-heated at this condition to maximize biomass heating. At the end of preheating, the biomass was compressed again to the required level and the heating was continued in the fully compressed stage for the activation of binder. At the end of compression, the pressure in the compression section 24 was relieved and the gate 40 was opened. The total process time is calculated as the sum of the preheating time and heating time inside the compression section 24. The process time was measured and controlled using the timers connected in the control circuits. Before the start of each experiment, the machine was run without loading the biomass, and the time in each section was measured, and necessary adjustments were made if any timer changes were needed to get the correct process time.

The log density was measured as a ratio of weight of the log to the volume of the log. The weight of each log was measured using a pan balance having a sensitivity of 0.04 lbs. The volume of the log was calculated from the diameter and height of the log measured using vernier calipers. During experiments, we observed that there was no radial expansion of logs once ejected from the test equipment, and the diameter of the logs was always 11″, equivalent to the cylinder internal diameter in the cooling section 28. The height of the logs was measured at 3 points using the vernier caliper. The average of the height and diameter was used to arrive at the volume of the logs, assuming the logs to have a perfectly cylindrical shape. The measured weight and volume were used to calculate the density of logs.

The quality of logs made in the field test equipment was better than the logs made in the smaller-scale lab testing equipment. This is due to the fact that the total cooling time was equal to the process time in the lab testing equipment, whereas the total cooling time in the field testing equipment is equal to 8 to 12 times of the heating time. This extra cooling time is due to the long cooling section 28 on the field test equipment. With this extra cooling, it is believed that the binder has better setting characteristics throughout the log thereby reducing spring-back of the material once the log is ejected from the barrel exit 21. This result is achieved even though forced cooling was only provided on the circumference of the logs at the cooling section 28. Post ejection inspection of logs showed that binding was observed on both ends of the log, as well as the circumference.

Different biomass loading methods were tried and test results are given below in TABLE 6. Loading methods were driven somewhat by the type of bales of switchgrass and wheat straw that were available for testing. Among the four different loading methods, two methods were tested to decrease the loading time, and the two other methods were tested to reduce the spring-back of the logs. Test results are given in TABLE 6. It was clear that loading in the form of bale flakes resulted in reduced loading time and straw loading in the direction perpendicular to the pressing direction resulted in less spring-back. Hence all the subsequent tests were completed by feeding the biomass in the form of flakes and maintaining the straw direction perpendicular to the pressing direction in the field test equipment.

TABLE 6
effect of loading conditions on log quality

| SI. | | |
|---|---|---|
| No. | Loading method | Quality |
| 1 | Feeding in the form of | Best form and orientation. Helps in |
| | flakes of bales | faster loading. Results in good |
| | | quality logs. |
| 2 | Feeding in the form of | Log quality made from sized bales |
| | sized bales | was poor. The time needed to prepare |
| | | the bale was high |
| 3 | Direction of straw | Spring-back was higher and required |
| | parallel to | more cooling to set the biomass |
| | pressing axis | |
| 4 | Direction of straw | Good loading condition, results in |
| | perpendicular | reduced pressure requirement and good |
| | to pressing axis. | quality logs. |

The effects of hot oil temperature variation were conducted by controlling the oil temperature to 350° F. and 400° F. In the lab, the temperature of a heating section was maintained at 350° F. using electrical heaters and a rheostat. The rheostat setting was driven by measuring the inside surface temperature of the heating zone. During lab testing, using smaller-scale equipment and electric heaters, it was observed that increasing the temperature above 350° F. resulted in biomass charring. But in the field test equipment, the temperature on the inside surface was maintained using hot oil circulation. There was no observed biomass charring, even at an oil temperature of 400° F. Most of the components, such as swivel fittings connected to pusher line and the flexible hoses etc., had an operating temperature limit of 400° F. Hence the tests were carried out at an oil temperature of 400° F. (204 C) to maximize heating rate while avoiding equipment degradation.

The average Celsius temperature recorded at different points in the compression section 24 is given in TABLE 7.

TABLE 7
Average temperature of hot oil during log making process

| | Temperature measured at different zones, ° C. | | | | | |
|---|---|---|---|---|---|---|
| Process | Heating section 24 | | | | | |
| time, | walls | | Gate 40 | | Piston head 32 | |
| sec | inlet | Outlet | Inlet | Outlet | inlet | Outlet |
| 360 | 202.3 | 199.7 | 201.6 | 197.9 | 202.1 | 197.8 |
| 210 | 201.5 | 199.0 | 200.9 | 197.6 | 201.0 | 196.5 |
| 120 | 201.7 | 198.6 | 201.3 | 197.9 | 201.5 | 197.1 |
| 120 | 201.6 | 198.2 | 200.9 | 197.9 | 201.4 | 196.5 |
| 90 | 202.5 | 198.2 | 201.7 | 198.5 | 201.9 | 197.0 |

The flow rate of oil to the compression section 24 jacket, gate 40 and piston head 32 was maintained at 12 gpm, 4 gpm and 4 gpm, respectively. The total heat transferred from the oil to the equipment calculated based on the oil flow rate, temperature reduction between the inlet and outlet and specific heat of the oil at 400° F., was 9.6 KW.

Based on lab tests it was observed that the maximum allowable surface temperature after cooling was found to be 90° F. Hence, the cooling system was designed to maintain surface temperature of 90° F. The actual temperature of oil recorded in the inlet and outlet of cooling section 28 is given in TABLE 8. From this table it is apparent the cooling system described earlier can provide sufficient cooling capabilities. Also, final log density showed that the setting temperature of 90° F. (32.2 C) is sufficient to maintain log integrity.

TABLE 8
Average oil temperature in cooling section

Temperature measured at cooling zones, ° C.

| Process time, sec | Inlet | outlet |
|---|---|---|
| 360 | 27.1 | 34.4 |
| 210 | 25.3 | 33.4 |
| 120 | 26.8 | 34.9 |
| 120 | 27.1 | 34.9 |
| 90 | 26.5 | 34.8 |

Multiple tests were carried out by varying the process time from 90 seconds to 300 seconds. The pre heating and compression time tested is given in TABLE 9. From the table, it can be concluded that the field test equipment can be operated at a capacity of 3.8 tons/day using the commercially available bales of size 18″×22″×40″. If the correct size bales are available for feeding, the feed density is increased and preparation time is reduced. In this case, the field test equipment can operated at 7.0 tons/day.

TABLE 9
Effect of process time on Capacity

| | | | | | Capacity of |
|---|---|---|---|---|---|
| | Process time, sec | | | Density of | equipment, |
| SI. No. | Pre-heating | Compression | Total | logs, lbs/cf | tons/day |
| 1 | 60 | 300 | 360 | 33.7 | 0.9 |
| 2 | 30 | 180 | 210 | 36.8 | 1.6 |
| 3 | 30 | 90 | 120 | 39.3 | 3.0 |
| 4 | 30 | 90 | 120 | 35.9 | 3.0 |
| 5 | 30 | 90 | 120 | 26.7 | 3.5 |
| 6 | 30 | 90 | 120 | 35.6 | 3.5 |
| 7 | 15 | 75 | 90 | 38.5 | 3.8 |

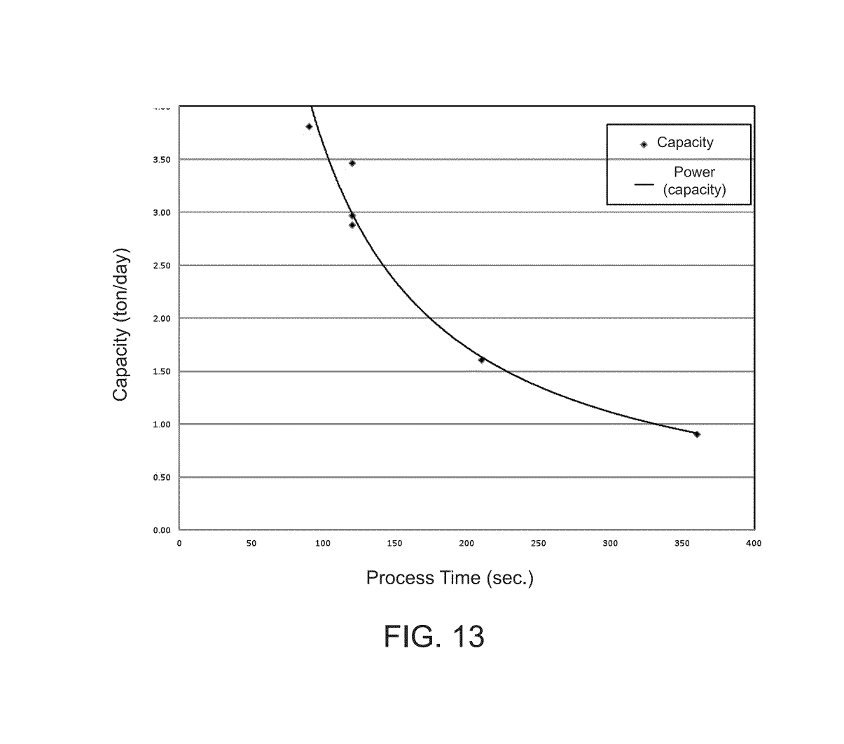

FIG. 13 plots the effects of process time on capacity. As the process time increases, the field capacity decreases. However, the two are not linearly correlated. Among the various correlations tried, such as logarithmic, power, and exponential relationship, the power relationship was found to fit well with maximum R² value of 0.98. The process time is correlated with capacity with the equation y=527.77x^{-1.081}. This shows that the capacity of the equipment is not dependent on process time alone. The capacity of the equipment depends on process time, level of compression in the heating zone, back pressure developed in the cooling zone, etc.

The log density reported was calculated as the average of density of all the logs made under a specific condition. As explained in subsequent sections, the density of logs made before reaching a steady state (i.e., full back pressure in the final cooling section) was much lower than the density of logs made during steady state conditions. The steady state conditions are reached once the entire cooling section is filled with biomass logs and the maximum back pressure has been reached for that test condition. Depending upon the level of compaction in the compression section 24, 8 to 12 logs could fit inside the cooling section 28 at steady state conditions.

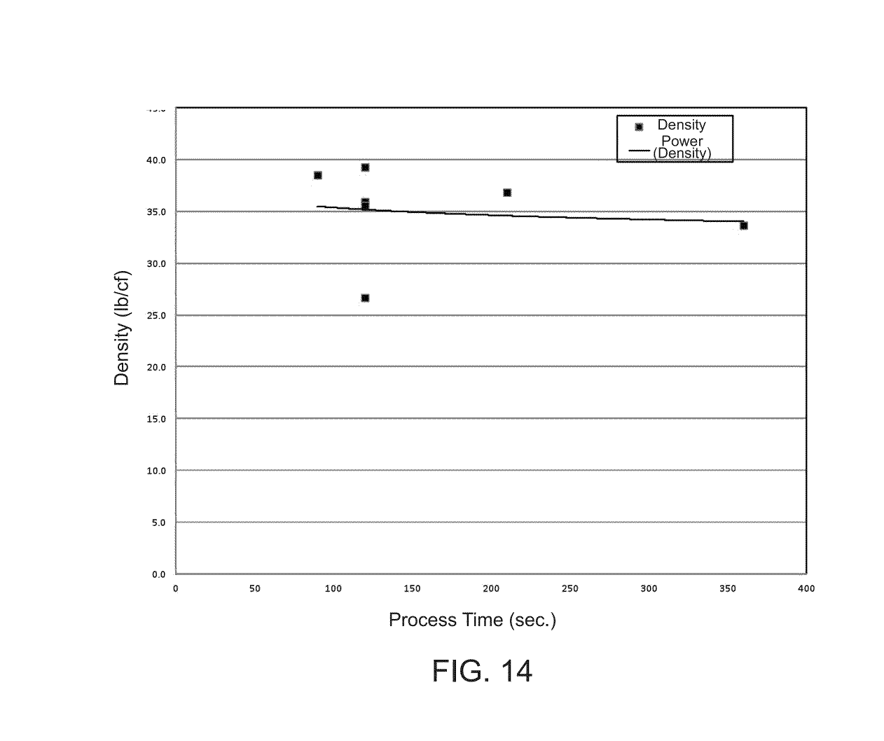

The effect of process time on log density produced is given in FIG. 14. From the figure, even though the maximum density obtained was 40 lb/cf, the density of individual logs made during the steady state condition was higher than the average density shown in the figure. The density of many of the logs made using the field test equipment was above 50 lb/cf. Process time had the least effect on the density of switchgrass logs, which can be understood from the correlation shown in FIG. 14. Various models were tried to correlate the effect of process time on density. None of the correlation coefficients were found to be above 0.01 indicating that processing time had the least effect on density.

For efficient gate 40 operation without any problems, the piston head 32 movement beyond the gate 32 is important. During initial trials, the distance beyond the gate 40 was adjusted to 1″. At 1″ distance beyond gate 40, depending on the processing time and level of compaction, sometimes the spring back was greater than 1″, closing the gap to the gate 40. As a result, the biomass could move between the gate 40 and cooling section 28 flange, which could jam the gate 40. As the distance was increased to 2″, even though the gate 40 jamming stopped, it gave more space for spring back in the cooling section. This spring back in the cooling section resulted in reduced log density.

The results of the level of compaction in the field test equipment are given in TABLE 10. It was expected that, as the distance beyond the gate 40 increased, the expected log density decreased. This trend was observed during testing. At a compression distance of 3″, increasing the distance beyond the gate 40 from 1″ to 2 resulted in reduction of density of 9%. In the same way, increasing the distance beyond gate 40 from 1″ to 2″ at a compression distance of 4″ resulted in a reduction in density of 25%.

TABLE 10
Effect of level of compaction beyond gate on log density

| | Distance, in | | Calculated | Actual |
|---|---|---|---|---|
| SI. No. | Front of gate | beyond gate | density, lb/cf | density, lbs/cf |
| 1 | 3.0 | 1.0 | 38.7 | 39.3 |
| 2 | 4.0 | 1.0 | 30.9 | 35.9 |
| 3 | 3.0 | 2.0 | 30.9 | 35.6 |
| 4 | 4.0 | 2.0 | 25.8 | 26.7 |

As explained earlier, it was observed that 8 to 12 logs could be present inside the cooling section 28, depending on the level of compression and distance beyond the gate 40. TABLE 11 is an example of density of logs made during initial startup period. From the table, the density of a first log made was only 25 lbs/cf compared to the density of 46 l/cf made during steady state condition. As the number of logs present inside the cooling section 28 increases, the density of logs also increases until reaching a steady state condition. The steady state condition was attained as the entire cooling section 28 was filled with biomass logs. From this, the level of back pressure in the cooling section 28 has a very significant effect on the log density.

TABLE 11
Effect of back pressure in cooling section on log density

| Process time, | Number of logs in | Height of log, | Density of log, |
|---|---|---|---|
| sec | the cooling section | inches | lbs/cf |
| 210 | 0 | 5.5 | 25.2 |
| 210 | 1 | 5 | 28.7 |
| 210 | 2 | 4.5 | 31.3 |
| 210 | 3 | 4.5 | 31.8 |
| 210 | 4 | 4 | 35.8 |
| 210 | 5 | 3.8 | 38.9 |
| 210 | 6 | 3.6 | 39.8 |
| 210 | 7 | 3.5 | 40.3 |
| 210 | 8 | 3.75 | 38.8 |
| 210 | 9 | 3.6 | 40.4 |
| 210 | 10 | 3.5 | 39.0 |
| 210 | 10 | 3 | 46.2 |
| 210 | 10 | 3.25 | 42.7 |

The average moisture contents of the different biomass materials tested are given in TABLE 12. Switchgrass and miscanthus were harvested a month before testing and stored at the field condition. Hence it has dried to a moisture content of about 11%. Corn stover was also harvested in the field and allowed to dry before testing. Hence the moisture content of corn stover was reduced to below 10%. However, the moisture content of wheat straw and rice straw were 20% and above. Rice straw and wheat straw were obtained from a local feed market and were fresh. Even though alfalfa is obtained from the feed market, the moisture content is around 10%. Alfalfa is used as a feed and selling price was much higher compared to other biomass. Hence alfalfa is dried to optimum moisture content in the field before baling.

TABLE 12
Moisture content of different biomass material

| SI. No | Biomass | % Moisture content (as-is) |
|---|---|---|
| 1 | Switchgrass | 11.1 |
| 2 | Miscanthus | 10.9 |
| 3 | Corn stover | 9.8 |
| 4 | Wheat straw | 25.5 |
| 5 | Rice straw | 19.4 |
| 6 | Alfalfa | 11.8 |

The oil temperature recorded in the heating section 24, gate 40, piston head 32 and cooling section 28 at different times of the day are given in TABLE 13. From the table the maximum coolant temperature in the cooling section was observed to be less than 95° F. which shows that coolant at ambient temperature is sufficient for producing good quality logs. There was little difference in the temperature of the oil recorded in the heating section measured at different times of the day. The temperature recorded in the morning is lower than the oil temperature recorded later. This is due to more heat loss from the surface of the heating parts in the morning hours at the lower ambient temperatures.

TABLE 13
Temperature of oil at different sections of equipment

| | Temperature of oil ° F. | | | | | | | |
|---|---|---|---|---|---|---|---|---|
| | | | Piston | | | Piston | | |
| Time of | Gate | Heating | head | Heating | Gate | head | Cooling | Cooling |
| the day | out | in | in | out | in | out | in | out |
| Morning | 383.4 | 383.7 | 379.1 | 376.6 | 377.4 | 365.8 | 84.0 | 85.9 |
| Noon | 393.8 | 394.4 | 395.5 | 391.0 | 386.6 | 386.0 | 87.9 | 90.8 |
| Afternoon | 396.1 | 396.9 | 397.6 | 392.9 | 388.3 | 388.9 | 89.6 | 91.7 |

Good quality logs were made from six different biomass materials during testing. The average temperature of heating oil and cooling oil recorded during testing with the different biomass material in the open field conditions is given in the TABLE 14. There was no significant difference in temperature of oil at different sections during testing with six different materials. The density of logs made during field demonstration is given in the TABLE 15.

TABLE 14
Average oil temperature for six different biomass material

| | Temperature of oil ° F. | | | | | | | |
|---|---|---|---|---|---|---|---|---|
| | | | Piston | Piston | | | | |
| | Heating | Heating | head | head | Gate | Gate | Cooling | Cooling |
| Biomass | in | out | out | in | in | out | in | out |
| Miscanthus | 383.7 | 376.6 | 365.8 | 379.1 | 377.4 | 383.4 | 84.0 | 85.9 |
| Wheat straw | 394.4 | 391.0 | 386.0 | 395.5 | 386.6 | 393.8 | 87.9 | 90.8 |
| Alfalfa | 379.2 | 375.0 | 369.9 | 379.5 | 371.4 | 378.3 | 85.7 | 88.1 |
| Rice straw | 394.5 | 390.8 | 385.9 | 395.5 | 385.6 | 393.6 | 87.9 | 90.7 |
| Switchgrass | 396.9 | 392.9 | 388.9 | 397.6 | 388.3 | 396.1 | 89.6 | 91.7 |
| Corn stove | 388.6 | 384.4 | 379.3 | 389.0 | 380.4 | 387.9 | 92.7 | 85.5 |

TABLE 15
Density of logs for different biomass material

| SI. No | Biomass | Density (lb/cf) |
|---|---|---|
| 1 | Switchgrass | 36.4 |
| 2 | Miscanthus | 37.4 |
| 3 | Corn stover | 34.0 |
| 4 | Wheat straw | 32.6 |
| 5 | Rice straw | 29.3 |
| 6 | Alfalfa | 37.6 |

In the case of all the six biomass materials the total process time was set to 90 seconds. Depending on the nature of biomass 6.5 to 8.5 lbs of biomass was fed into the feeding section 22. In the case of rice straw and alfalfa, the inherent density of the biomass in the bales was less and it was possible to only feed 6.5 to 7.5 lbs of loose biomass. In the case of switchgrass and miscanthus, even though the moisture content was lower, 7.5 lbs to 8.5 lbs of biomass could be easily fed into the feeding section. In the case of dry corn stover, around 7.5 lbs of biomass could be fed into the feeding section. In all cases, the biomass was compressed to a height of 3″ beyond the gate 40. In the case of Alfalfa, even though the weight of biomass fed in to the feeding section 22 was lower, the final density was more than 35 lb/cf, due to the good binding nature of this material and less spring back. In the case of wheat straw, even though more biomass was fed into the feeding section 22, the final density was less because the moisture content of wheat straw was more than 20%, and more spring back was observed.

Drops tests were conducted to determine the strength of the logs. The logs were dropped from a distance of more than 10 feet onto a concrete floor for a number of times. It was observed that there were no breakaway parts or loose biomass dislodged from the logs even after dropping for more than 10 times. Video recordings of the drop tests showed that there was no debris remaining on the testing floor, showing that these logs can be transported in vehicles using bulk handling equipment, such as a front loader etc.

A comparison of log forming process for compacting biomass material is compared to pelleting and cubing processes is set forth in TABLE 16. As shown in the table the log forming process provides a substantial reduction in total energy for production of logs.

TABLE 16
Comparison of log process to pelleting and cubing

| | Cubing | Pelleting | log |
|---|---|---|---|
| | process | process | process |
| Motor hp | 380 | 400 | 60 |
| Capacity, t/hr | 4 | 4 | 4 |
| Eletctrical energy, kwh/ton | 69.92 | 73.6 | 11.04 |
| Thermal energy, kwh/ton | 0 | 0 | 14.75 |
| Total energy, kwh/ton | 69.92 | 73.6 | 25.79 |
| Log process electrical | 84.2 | 85.0 | — |
| energy reduction, % | | | |
| Log process total energy | 63.1 | 65.0 | — |
| reduction, % | | | |

The cubing system can produce densified biomass with lower density compared to the pelleting process and log forming process under field test conditions. Pelleting and log formation can produce densified biomass of similar density but the formats are different, with pellets typically smaller than logs.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the claims should not be construed to limit the invention to the specific embodiments disclosed in the specification. Rather, the scope of the invention is to be determined entirely by the claims, which are to be construed in accordance with established doctrines of claim interpretation.

What is claimed is:

1. A method for densification of a material, comprising the steps of:
compressing the material to form a log; and
while maintaining the log in a compressed state,
heating the log to activate a binder, and
then cooling the log to set the binder.

2. The method of claim 1, wherein at least a portion of the heating step occurs at the same time as the compressing step.

3. The method of claim 1 wherein first sides of the log are heated during the compression step and second sides of the log are heated when the log is maintained in a compressed state.

4. The method of claim 1, further including the step of simultaneously heating and cooling a plurality of logs following the compressing step.

5. The method of claim 1, wherein the log is a first log that is pushed into a plurality of other logs, followed by the step of compressing a second log and then pushing the second log into the first log.

6. The method of claim 1, wherein the material is lignocellulosic biomass material.

7. The method of claim 1, wherein the material has a density of less than about 10 lb/cf and the log has a density of at least 30 lb/cf.

8. The method of claim 1, wherein the binder is activated and set at substantially only the periphery of the log.

9. The method of claim 1, wherein the heating is provided by a circulating fluid.

10. The method of claim 1, wherein the cooling is provided by a circulating fluid.

11. The method of claim 1, wherein
the compression step duration is t1,
the binder has a heat activation time of t2, and
the heating step includes simultaneously heating N logs (N>2), such that t1 is approximately equal to, or less than (1/N)*t2.

12. An apparatus for compacting biomass material, comprising:
a barrel including a heating section and cooling section;
a heat source coupled to the heating section; and
a piston ram configured for being actuated to compress the material into a first log and push the first log into a second log disposed in one of the heating and cooling sections.

13. The apparatus of claim 12, further including a barrier gate coupled to an actuator for positioning the barrier gate between a compression section and the heating and cooling sections.

14. The apparatus of claim 12, wherein the barrel comprises the compression section and the piston ram extends through the compression section to compress the material between the piston ram and barrier gate.

15. The apparatus of claim 12, wherein the heating section comprises a compression section for heating the material while the material is being compressed into the first log.

16. The apparatus of claim 12, wherein the heating section and cooling section provide a fixed space for holding the logs such that the logs are maintained at about the same dimensions when heated and cooled.

17. A system for densifying material, comprising
a press for compressing the material into logs; and
a structure, coupled to the press and holding under compression a plurality of such logs that were received from the press, the structure including a heating section and a cooling section for simultaneously activating and setting binder in the logs.

18. The system of claim 17, wherein the material is baled, lignocellulosic biomass material.

19. The system of claim 18, wherein the material has a density of less than about 10 lb/cf and the logs have a density of at least about 30 lb/cf.

20. The system of claim 19, wherein the system has a total energy usage of about 25 Kwh per ton of logs produced.

21. The method of claim 1, wherein the log is heated by surface heating.

22. The method of claim 21, wherein the log is heated by surface contact between the log outer surface and a heated wall maintaining the log in the compressed state.

23. The method of claim 1, wherein the log is heated and cooled by surface contact between the log outer surface and a heated and cooled wall, respectively.

24. The method of claim 1, wherein a substantial portion of the material of the log is not heated to an activation temperature for the binder.
